(19) United States
(12) Patent Application Publication
(10) Pub. No.: US 2026/0072219 A1
(43) Pub. Date: Mar. 12, 2026

(54) DUST CAP HAVING CONTROLLED DEFORMATION FOR OPTICAL FIBER CONNECTORS

(71) Applicant: CORNING RESEARCH & DEVELOPMENT CORPORATION, Corning, NY (US)

(72) Inventors: Tessa Marie Carreno, Haslet, TX (US); Louis Edward Parkman, III, Keller, TX (US)

(21) Appl. No.: 19/299,777

(22) Filed: Aug. 14, 2025

Related U.S. Application Data
(60) Provisional application No. 63/691,380, filed on Sep. 6, 2024.

(51) Int. Cl. G02B 6/38

(52) U.S. Cl. CPC G02B 6/3849; G02B 6/3853; G02B 6/3885; G02B 6/3893

(57) ABSTRACT

The present disclosure relates to a dust cap that is coupled to a fiber optic connector via an interference fit between the dust cap and a connector housing of the fiber optic connector. The dust cap has a first wall section having a first thickness and a second wall section having a second thickness greater than the first thickness such that when the dust cap is coupled to the connector housing via an interference fit, the first wall section deforms and thereby provides a seal of the fiber optic connector. The dust cap may also include a lensing element.

### PRIORITY APPLICATION

This application claims the benefit of priority of U.S. Provisional Application No. 63/691,380, filed on September 6, 2024, the content of which is relied upon and incorporated herein by reference in its entirety.

### FIELD OF THE DISCLOSURE

This disclosure relates to fiber optic connectors and fiber optic cable assemblies used in telecommunication systems, and in particular relates to dust caps used with the fiber optic connectors.

### BACKGROUND OF THE DISCLOSURE

Optical fibers are useful in a wide variety of applications, including the telecommunications industry for voice, video, and data transmissions. Benefits of optical fiber include extremely wide bandwidth and low noise operation. In a telecommunications system that uses optical fibers, there are typically many locations where fiber optic cables carrying the optical fibers connect to equipment or other fiber optic cables. To conveniently provide these connections, fiber optic connectors are often provided on the ends of fiber optic cables.

A fiber optic connector typically includes a ferrule with one or more bores that receive one or more optical fibers. A housing that surrounds at least a portion of the ferrule defines features for mechanically retaining the fiber optic connector with another component (e.g. an adapter), which may include features for aligning the ferrule with a mating ferrule (e.g., from another fiber optic connector). Thus, when the housing of the fiber optic connector is mated with the other component, the optical fiber(s) in the ferrule can be held in alignment with the optical fiber(s) of the mating ferrule to establish an optical connection.

At interconnections between fiber optic connectors, light exiting each optical fiber terminated by a first fiber optic connector (e.g., on an end of a first fiber optic cable) is introduced into a corresponding optical fiber within an adjacent, second fiber optic connector (which may be on an end of a second fiber optic cable). The light travels in respective cores of the optical fibers. If optical fiber cores at an interconnection between first and second optical fibers are misaligned, then transmission of a fraction of an optical signal from the core of the first optical fiber to the core of the second optical fiber may be inhibited, resulting in signal degradation at the interconnection. Furthermore, and more salient to the present disclosure, if contamination such as one or more pieces of debris is present on an end face of the ferrule of either of the fiber optic connectors that terminate the optical fibers, then transmission of optical signals from the core of the first optical fiber to the core of the second optical fiber optic may be inhibited. Unlike in conductive wire cable connectors, dust, dirt, and other contaminants are a particular problem in optical connections because they affect the passage of light from one optical fiber to another, and signals borne by the light may be poorly transmitted, or not transmitted at all. Ferrule end faces of fiber optic connectors must therefore be kept clean to ensure long operational life and to minimize signal loss at connection points.

To that end, a dust cap is typically coupled to the ferrule of a fiber optic connector in an effort to preserve the cleanliness of the end face until the fiber optic connector is mated with another connector. For example, the manufacturer of a fiber optic cable assembly that includes the fiber optic connector may conduct an initial cleaning and inspection of the ferrule end face after termination steps, and immediately thereafter couple the dust cap to the ferrule. Conventional cleaning systems may include clickers, wipes, or sprays of air and solvent to clean the ferrule end face, while conventional inspection systems may include image-based inspection systems configured to visualize the ferrule end face via optical microscopy.

In any event, a customer may subsequently remove the dust cap to conduct a further cleaning and/or inspection of the ferrule end face prior to installation. In many cases, the cleaning and/or inspection of the ferrule end face performed by the customer is counterproductive and may actually introduce additional contamination to the ferrule end face. In this regard, the removal of the dust cap from the ferrule exposes the ferrule end face to potential contamination during handling of the connector. Moreover, the cleaning of the ferrule end face by the customer may introduce additional contamination via the cleaning material itself, and the inspection of the ferrule end face by the customer may introduce additional contamination via cross-contamination at the fixture of the inspection system.

In some cases, the coupling of the dust cap to the ferrule may introduce additional contamination to the ferrule end face. For example, the contact between the dust cap and the side(s) of the ferrule increase the risk of the dust cap also contacting and contaminating the ferrule end face. The contact between the dust cap and the side(s) of the ferrule may also introduce contamination to the side(s) of the ferrule, which may subsequently travel toward and onto the end face of the ferrule. In addition, the relative movement of the dust cap along the ferrule during coupling or removal of the dust cap may create static electric charges that may move or attract contamination, and/or may create contamination through chafing of the cap material onto the ferrule.

As such, improvements in the foregoing are desired.

### SUMMARY OF THE DISCLOSURE

In general, the present disclosure relates to a dust cap that is coupled to a fiber optic connector via an interference fit between the dust cap and a connector housing of the fiber optic connector. The dust cap has a first wall section having a first thickness and a second wall section having a second thickness greater than the first thickness such that when the dust cap is coupled to the connector housing via an interference fit, the first wall section deforms and thereby provides a seal of the fiber optic connector. The dust cap may also include a lensing element that comprises a first curved surface and a second curved surface where the first curved surface and the second curved surface each can be either concave or convex relative to a center of the lensing element. The lensing element provides a larger indication light due to this configuration.

In one embodiment, a dust cap for a fiber optic cable assembly that includes a fiber optic connector that includes a connector housing that houses at least one optical fiber and a ferrule that terminates the at least one optical fiber is provided. The dust cap comprising: a first end; a second end opposite the first end; a first wall section having a first thickness; a second wall section adjacent to the first wall section, the second wall section having a second thickness, the second thickness being greater than the first thickness; wherein the dust cap is configured to engage with the connector housing in an interference fit whereby at least one of the first wall section or the second wall section deforms.

In another embodiment, the first wall section includes a slit that extends from the first end of the dust cap. In another embodiment, the slit has a length less than about 5 mm. In another embodiment, the slit has a length ranging between about 1 mm and about 2 mm. In another embodiment, the first wall section comprises a plurality of first wall sections, and the second wall section comprises a plurality of second wall sections; wherein each second wall section is adjacent to at least one of the plurality of first wall sections. In another embodiment, the dust cap further comprising a lensing element at the second end of the dust cap, the lensing element comprising a first curved surface proximate the second end and a second curved surface at the second end. In another embodiment, the first curved surface is concave relative to a center of the lensing element and the second curved surface is concave relative to the center of the lensing element. In another embodiment, the first curved surface is convex relative to a center of the lensing element and the second curved surface is concave relative to the center of the lensing element. In another embodiment, the first curved surface is concave relative to a center of the lensing element and the second curved surface is convex relative to the center of the lensing element. In another embodiment, the first curved surface is convex relative to a center of the lensing element and the second curved surface is convex relative to the center of the lensing element.

In one embodiment, a dust cap for an optical connector is provided. The dust cap comprising: a first end; a second end opposite the first end; a plurality of first wall sections having a first thickness, each first wall section including a slit that extends from the first end of the dust cap; and a plurality of second wall sections each adjacent to at least one of the plurality of first wall sections, the second wall section having a second thickness, the second thickness being greater than the first thickness.

In another embodiment, the slit has a length less than about 5 mm. In another embodiment, the slit has a length ranging between about 1 mm and about 2 mm. In another embodiment, the dust cap further comprising a lensing element at the second end of the dust cap, the lensing element comprising a first curved surface proximate the second end and a second curved surface at the second end; wherein the first curved surface and the second curved surface each have an interior surface that face each other. In another embodiment, the first curved surface is convex and the second curved surface is concave. In another embodiment, the dust cap is inserted into a fiber optic cable assembly that includes: a fiber optic connector including a connector housing that houses at least one optical fiber and a ferrule that terminates the at least one optical fiber; wherein an interference fit is formed between the dust cap and the connector housing such that the interference fit creates a seal between the connector housing and the dust cap to prevent debris from entering into the fiber optic connector. In another embodiment, the plurality of first wall sections deform when the dust cap is inserted into a fiber optic cable assembly and the dust cap engages with a connector housing of the fiber optic cable assembly. In another embodiment, the dust cap is inserted into a fiber optic cable assembly that includes: a fiber optic connector including a connector housing that houses at least one optical fiber and a ferrule that terminates the at least one optical fiber; wherein an exterior surface of the dust cap contacts an exterior surface of the connector housing.

In one embodiment, a method of using and installing a dust cap for a fiber optic cable assembly that includes at least one optical fiber, a ferrule that terminates the at least one optical fiber, and a fiber optic connector that includes the ferrule, wherein the ferrule is housed within a connector housing of the fiber optic connector is provided. The method comprising: installing the dust cap in the connector housing, wherein an interference fit is formed between the dust cap and the connector housing to create a seal between the connector housing and the dust cap for preventing debris from entering into the fiber optic connector; wherein the dust cap comprises: a first end; a second end opposite the first end; a first wall section having a first thickness, wherein the first wall section includes a slit that extends from the first end of the dust cap; and a second wall section adjacent to the first wall section, the second wall section having a second thickness, the second thickness being greater than the first thickness; wherein when the dust cap forms interference fit with the connector housing, the first wall section deforms.

In another embodiment, the dust cap further comprises a lensing element at the second end of the dust cap, the lensing element comprising a first curved surface proximate the second end and a second curved surface at the second end. In another embodiment, the first curved surface is concave relative to a center of the lensing element and the second curved surface is concave relative to the center of the lensing element. In another embodiment, the first curved surface is convex relative to a center of the lensing element and the second curved surface is concave relative to the center of the lensing element. In another embodiment, the first curved surface is concave relative to a center of the lensing element and the second curved surface is convex relative to the center of the lensing element. In another embodiment, the first curved surface is convex relative to a center of the lensing element and the second curved surface is convex relative to the center of the lensing element.

Additional features and advantages will be set out in the detailed description which follows, and in part will be readily apparent to those skilled in the technical field of optical connectivity. It is to be understood that the foregoing general description, the following detailed description, and the accompanying drawings are merely exemplary and intended to provide an overview or framework to understand the nature and character of the claims.

### BRIEF DESCRIPTION OF THE DRAWINGS

The accompanying drawings are included to provide a further understanding, and are incorporated in and constitute a part of this specification. The drawings illustrate one or more embodiment(s), and together with the description serve to explain principles and operation of the various embodiments. Features and attributes associated with any of the embodiments shown or described may be applied to other embodiments shown, described, or appreciated based on this disclosure.

FIG. 1 a perspective view of a fiber optic connector assembly comprising a fiber optic connector with dust caps applied;

FIG. 2 is an exploded perspective view of the fiber optic connector assembly of FIG. 1;

FIG. 2A is an exploded, cross-sectional view of a portion of the fiber optic connector of FIG. 1 and one of the dust caps of FIG. 1;

FIG. 3 is a front, perspective view of one of the dust caps of FIG. 1;

FIG. 4 is a rear, perspective view of the dust cap of FIG. 1;

FIG. 5 is a cross sectional view of the dust cap of FIG. 1;

FIGS. 5A-5C are cross sectional views of alternate embodiments of dust caps according to this disclosure illustrating different shapes of a lensing element of the dust caps;

FIG. 6 is an exploded, perspective view of a portion of the fiber optic connector of FIG. 1 and the dust caps of FIG. 1, illustrating a method of installing the dust caps onto the fiber optic connector;

FIG. 7 is a cross sectional view of a portion of the fiber optic connector of FIG. 1 with a dust cap installed;

FIG. 8 is a cross sectional view of an alternate embodiment of a dust cap installed on a fiber optic connector; and

FIG. 9 is a front view of the fiber optic connector assembly of FIG. 1 illustrating a lensing element of the dust caps.

### DETAILED DESCRIPTION

Various embodiments will be clarified by examples in the description below. In general, the present disclosure relates to a dust cap that is coupled to a fiber optic connector via an interference fit between the dust cap and a connector housing of the fiber optic connector. The dust cap has a first wall section having a first thickness and a second wall section having a second thickness greater than the first thickness such that when the dust cap is coupled to the connector housing via an interference fit, the first wall section deforms and thereby provides a seal of the fiber optic connector. The dust cap may also include a lensing element that comprises a first curved surface and a second curved surface where the first curved surface and the second curved surface each can be either concave or convex relative to a center of the lensing element. The lensing element provides a larger indication light due to this configuration.

In this detailed description and elsewhere in this disclosure, references are made to “lengths” of components or elements. As discussed in the Background section above, fiber optic connectors include ferrules that receive one or more optical fibers, and skilled persons understand that the ferrules position an end section of each optical fiber along a respective longitudinal axis. The lengths discussed herein refer to distances along or parallel to such longitudinal axes. Additionally, the term “thickness” is used to refer to distances between inner and outer walls of a component, with such distances being in a plane orthogonal to the relevant longitudinal axis. Where components are generally cylindrical about a longitudinal axis, thickness is measured in a radial direction.

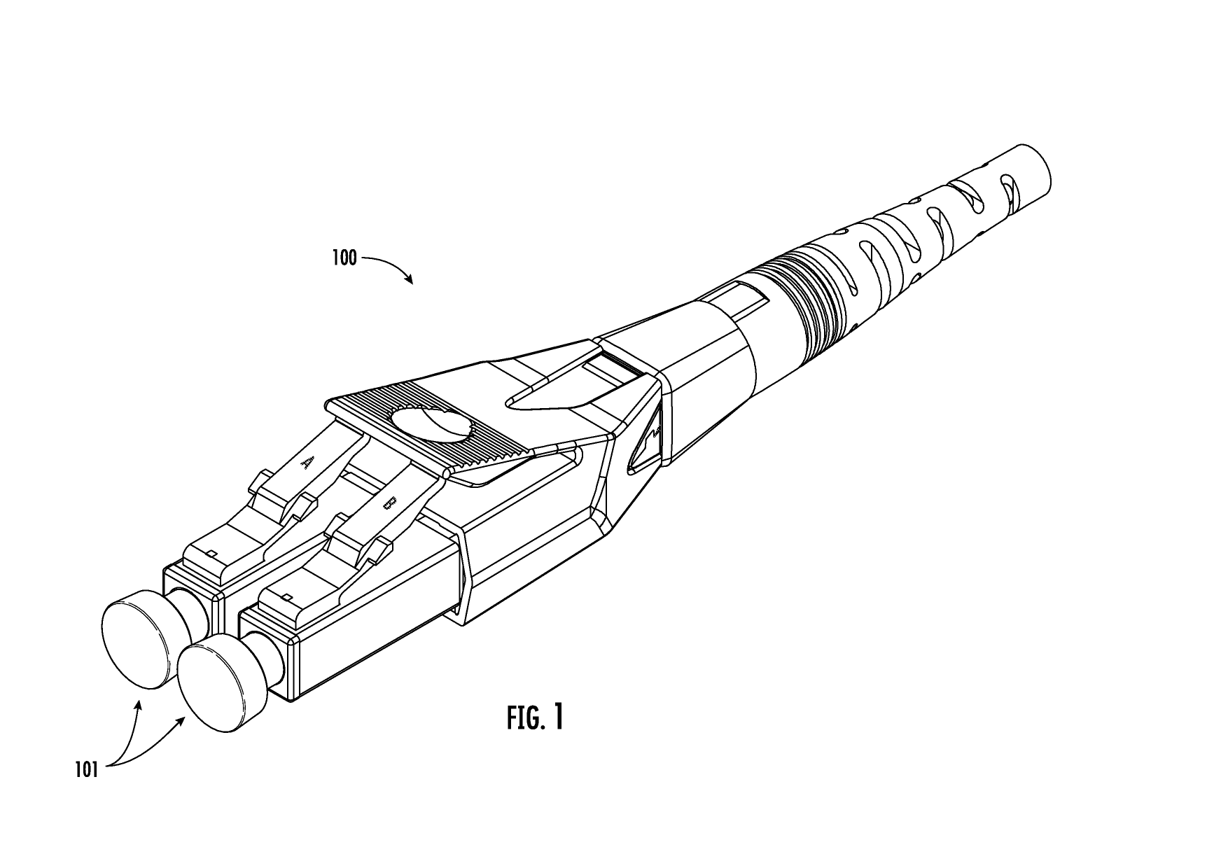

Referring first to FIG. 1, a fiber optic connector assembly 100 (also referred to as “optical connector 100”, or simply “connector 100”) with a dust cap 101 is shown. Although the connector 100 is shown in the form of a LC-type connector (e.g., according to IEC 61754-20), the disclosure below may be applicable to processes involving different fiber optic connector designs. This includes LC, SN and MDC (e.g., according to the QSFP-DD Multi-Source Agreement (MSA) Hardware Specification, Rev. 6.0, 2021, and the relevant documents cross-referenced therein), and MPO-type connectors, for example, and other single-fiber or multi-fiber connector designs. A general overview of the connector assembly 100 will be provided simply to facilitate discussion.

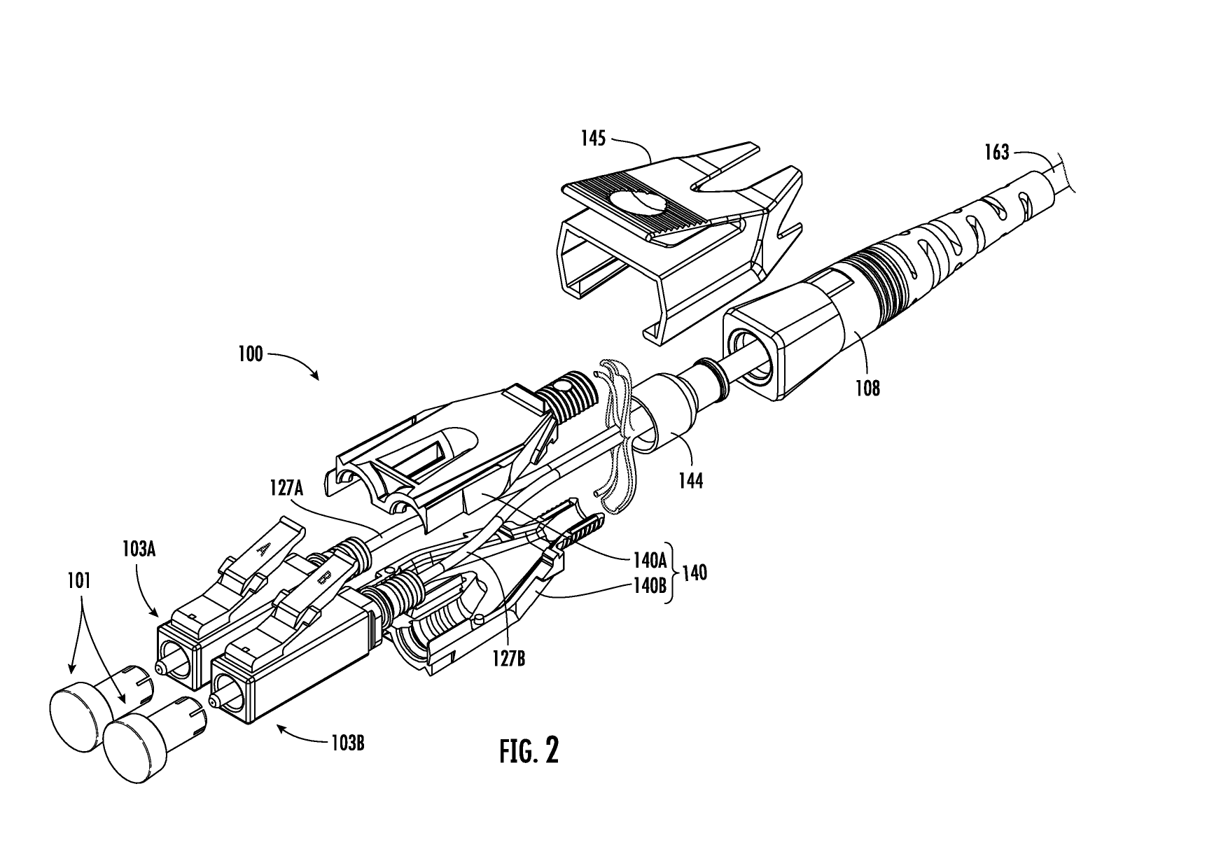

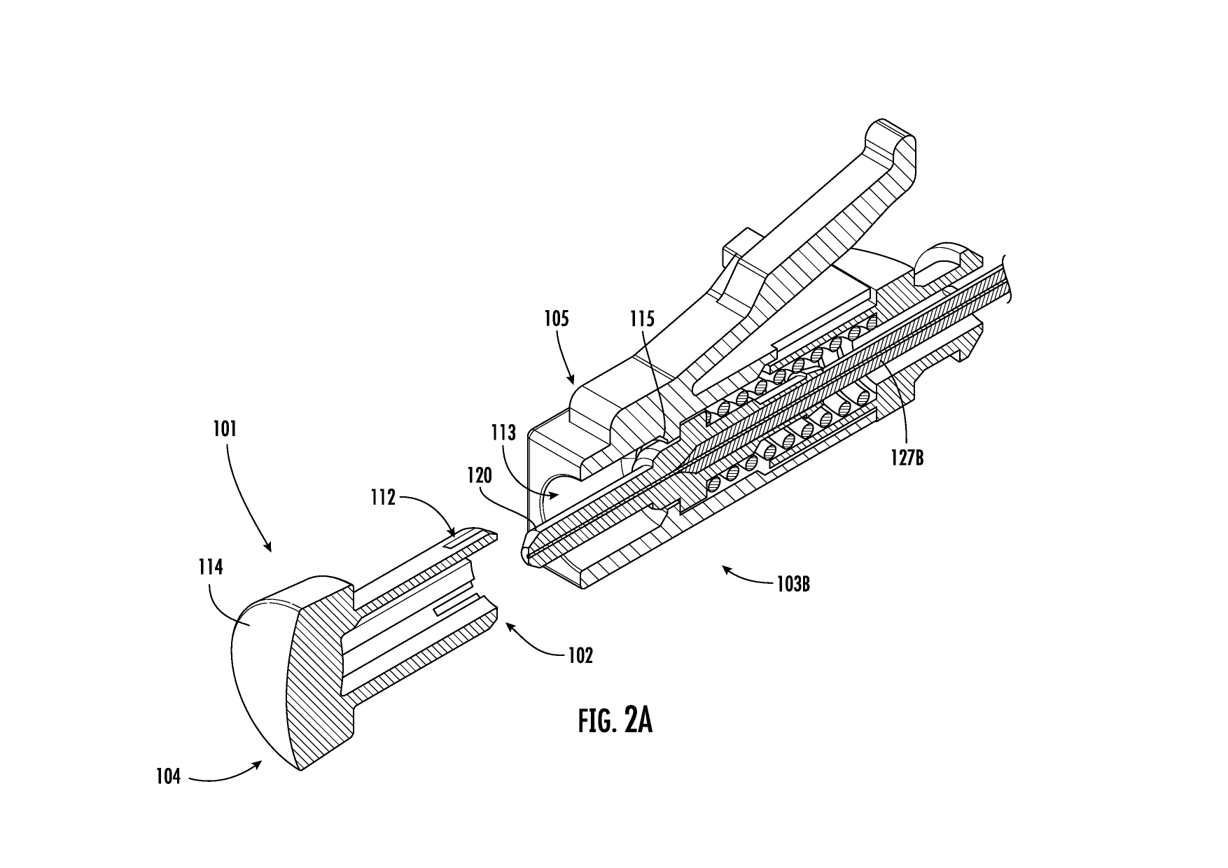

Referring now to FIG. 2, a partially exploded view of fiber optic connector assembly 100 is shown. The fiber optic connector assembly 100 includes a first fiber optic connector 103A, a second fiber optic connector 103B, a housing 140 for receiving the first and second fiber optic connectors 103A and 103B. In some embodiments, the first and second fiber optic connectors 103A and 103B may independently rotate along their respective longitudinal axes for polarity reversal within housing 140.

FIG. 2A illustrates connector 103B in further detail, but the description that follows applies equally to connector 103A such that both connectors 103A, 103B will be referenced. Fiber optic connectors 103A, 103B comprise a connector housing 105 that includes a recess 113 within the connector housing 105 as defined by connector housing wall 115. Recess 113 is where a ferrule 120 is positioned within connectors 103A, 103B, and as discussed in greater detail herein, dust caps 101 are received within the recess 113 and engage with the housing wall 115 to stay in place on connector 103A, 103B.

As shown, connectors 103A and 103B are attached to optical fibers 127A and 127B that extend from a fiber optic cable 163. The fiber optic cable 163 may be any suitable fiber optic cable or cables. By way of example, the fiber optic cable may include two unbuffered optical fibers generally surrounded by one or more strength elements and a cable jacket: however, other variations of the fiber optic cable may include buffered optical fibers and/or eliminate the strength elements or jacket. In this embodiment, fiber optic cable 163 is secured to the housing 140 by a crimp band 144 and a boot 108 fits over a portion of fiber optic cable 163 and the crimp band 144 until the boot 108 abuts the housing 140. Other variations of the fiber optic connector are possible. For instance, the fiber optic cable may have other crimp arrangements and/or use an epoxy or adhesive to secure the same to the fiber optic connector. In other embodiments, tubing may be positioned about optical fibers 127A and 127B within the housing 140, thereby providing bend control for inhibiting optical attenuation.

As depicted, a removable trigger mechanism 145 fits over the boot 108 and cable 163 and slides forward to engage the housing 140 and latches on the respective first fiber optic connector 103A and second fiber optic connector assembly 103B. The trigger 145 advantageously allows the craft to disengage both fiber optic connectors 103A, 103B by pushing on a single component (trigger 145) and also inhibits nearby fiber optic cables from snagging on the connectors 103A, 103B when the fiber optic connector assembly 100 is in use. The concepts disclosed herein may use any suitable simplex connector assembly for connectors 103A and 103B, such as LC, SC, or other suitable configurations.

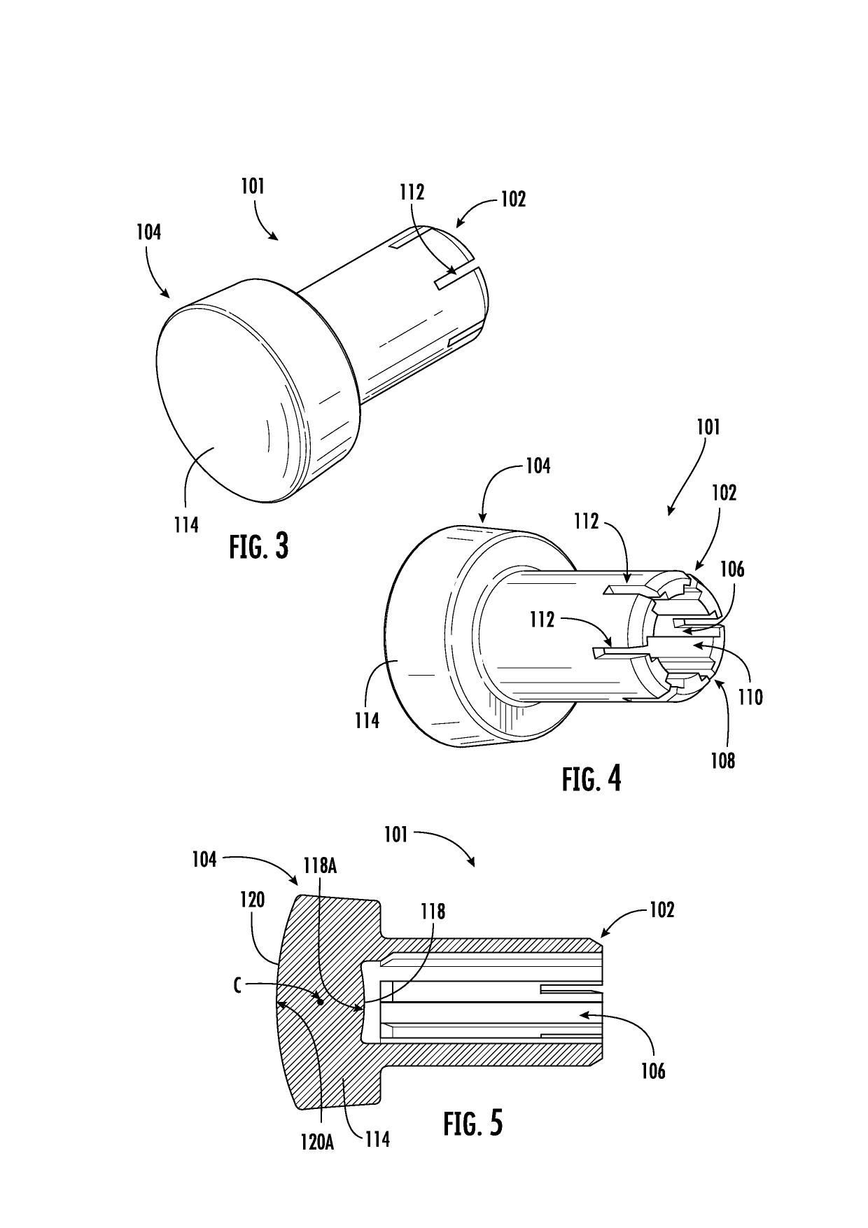

Referring to FIGS. 3-5, various views of one of the dust caps 101 are shown. Dust caps 101 are configured to protect the ferrule 120 and optical fiber 127A, 127B from damage by external factors (e.g., debris, dust, etc.). Each dust cap 101 comprises a first end 102 and a second end 104. At first end 102, dust cap 101 comprises an opening 106 that houses optical fiber 127A or 127B (or more specifically, ferrule 120 which terminates the optical fiber 127A or 127B) when dust cap 101 is applied onto connector 103A or 103B. Opening 106 extends from the first end 102 to the second end 104, and opening 106 is defined by first wall sections 108 and second wall sections 110. As shown, first wall sections 108 and second wall sections 110 are adjacent to each other in an alternating fashion. First wall sections 108 further each comprise a slit 112 that extend from the first end 102 of dust cap 101 towards the second end 104. In some embodiments, the length of the slit 112 is less than about 5 mm. In some embodiments, the length of slit 112 ranges between about 1 mm and about 2 mm. In some embodiments, slit 112 has a length that is about 1.6 mm.

First wall sections 108 and second wall sections 110 have a first thickness and second thickness, respectively. In some embodiments, the second wall sections 110 have the second thickness that is greater than the first thickness of the first wall sections 108. First wall section 108 and second wall sections 110 having different thicknesses enables controlled deformation of dust cap 101 when inserted into connectors 103A, 103B. In particular, as discussed herein, when dust cap 101 is inserted into connector housing 105, dust cap 101 engages with connector housing wall 115 in an interference fit, and in such a configuration, the first wall section 108 deforms upon insertion without contacting the ferrule 120 or optical fiber 127A, 127B. The interference fit creates a seal between the dust cap 101 and connector 103A, 103B such that ferrule 120 and optical fiber 127A, 127B are protected. While deformation of the first wall section 108 is discussed, it is within the scope of the present disclosure that in alternate embodiments, the second wall section 110 deforms when dust cap 101 is inserted into connectors 103A, 103B. It is also within the scope of the present disclosure that in alternate embodiments, at least one of the first wall section 108 or the second wall section 110 deform when inserting dust cap 101 into connectors 103A, 103B. In some embodiments, the first wall section 108 has a thickness greater than about 0.08 mm, and the second wall section 110 has a thickness less than about 1.46 mm.

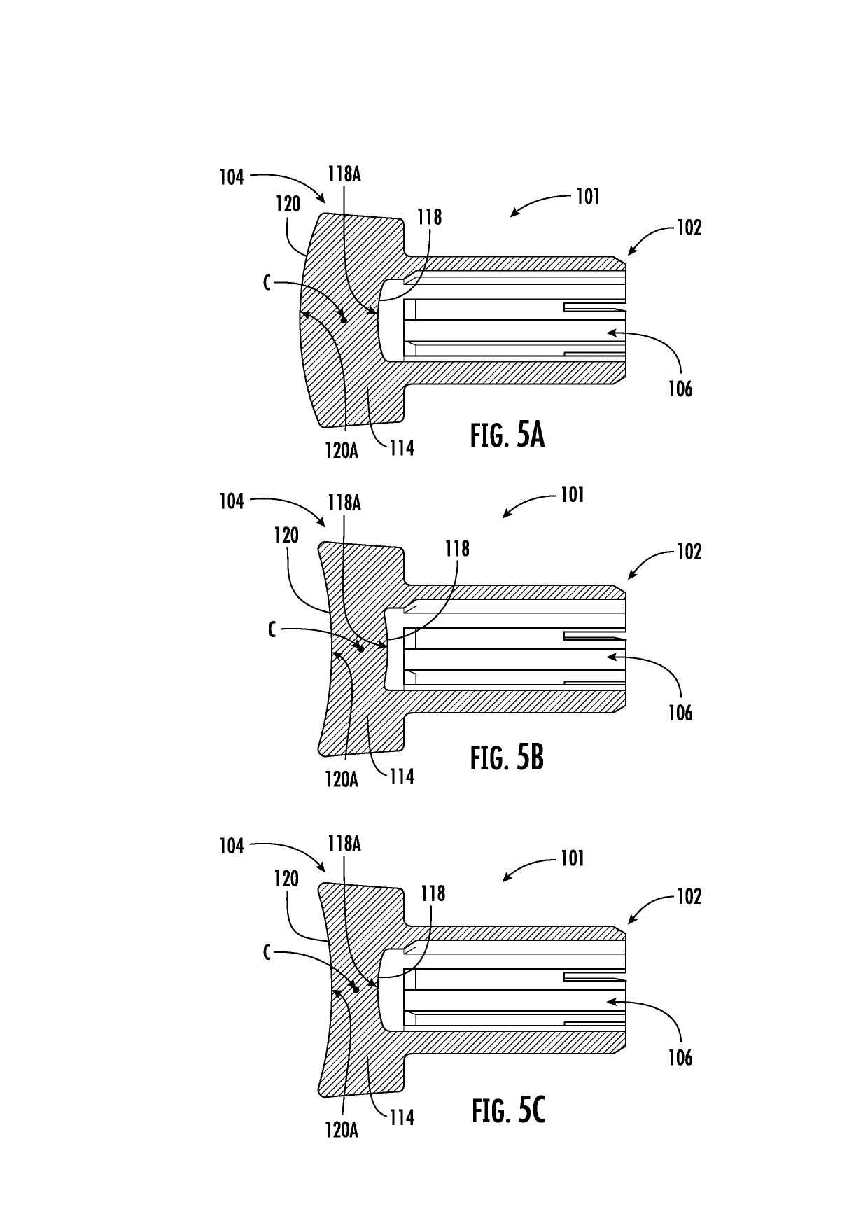

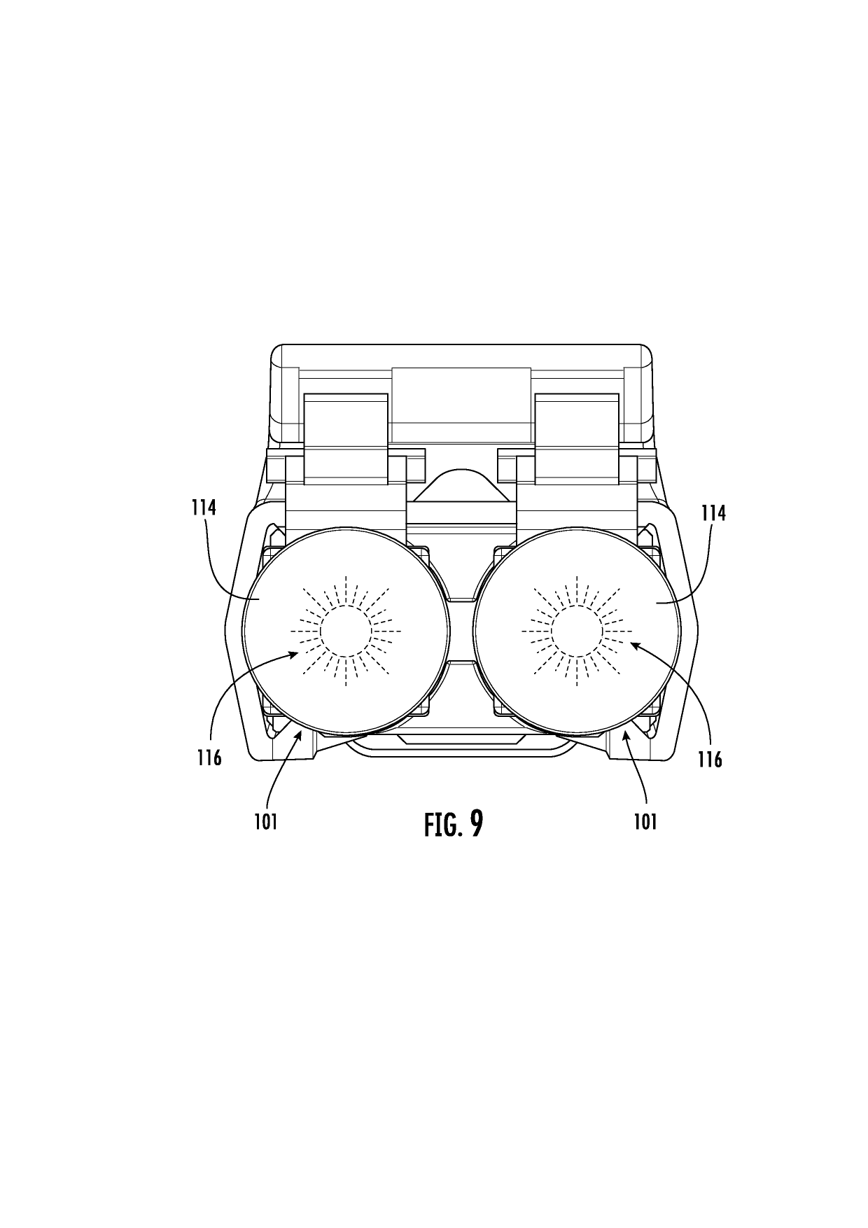

At second end 104 of dust cap 101, a lensing element 114 is provided. Lensing element 114 is configured to operate as a visual fault locator where a light can be emitted in the form of a visual indicator light 116 from the optical fiber 127A, 127B and through the lensing element 114 if the optical fiber 127A, 127B is intact as shown in FIG. 9. Similarly, if a light is not emitted at the lensing element 114, then there is a fault somewhere on optical fiber 127A, 127B. Lensing element 114 comprises a first curved surface 118 and a second curved surface 120. As shown, first curved surface 118 is distal to second end 104 relative to second curved surface 120. First curved surface 118 and second curved surface 120 each can be either concave or convex relative to a center C of lensing element 114. In some embodiments, first curved surface 118 is convex, and second curved surface 120 is convex as shown in FIG. 5. In some embodiments, first curved surface 118 is concave relative to center C of lensing element 114, and second curved surface 120 is convex relative to center C of lensing element 114 as shown in FIG. 5A. In some embodiments, first curved surface 118 is convex relative to center C of lensing element 114, and second curved surface 120 is concave relative to center C of lensing element 114 as shown in FIG. 5B. In some embodiments, first curved surface 118 is concave relative to center C of lensing element 114, and second curved surface 120 is concave relative to center C of lensing element 114 as shown in FIG. 5C. Stated another way, first curved surface 118 and second curved surface 120 face each other. That is, first curved surface 118 and second curved surface 120 have interior surfaces 118A, 120A that face each other.

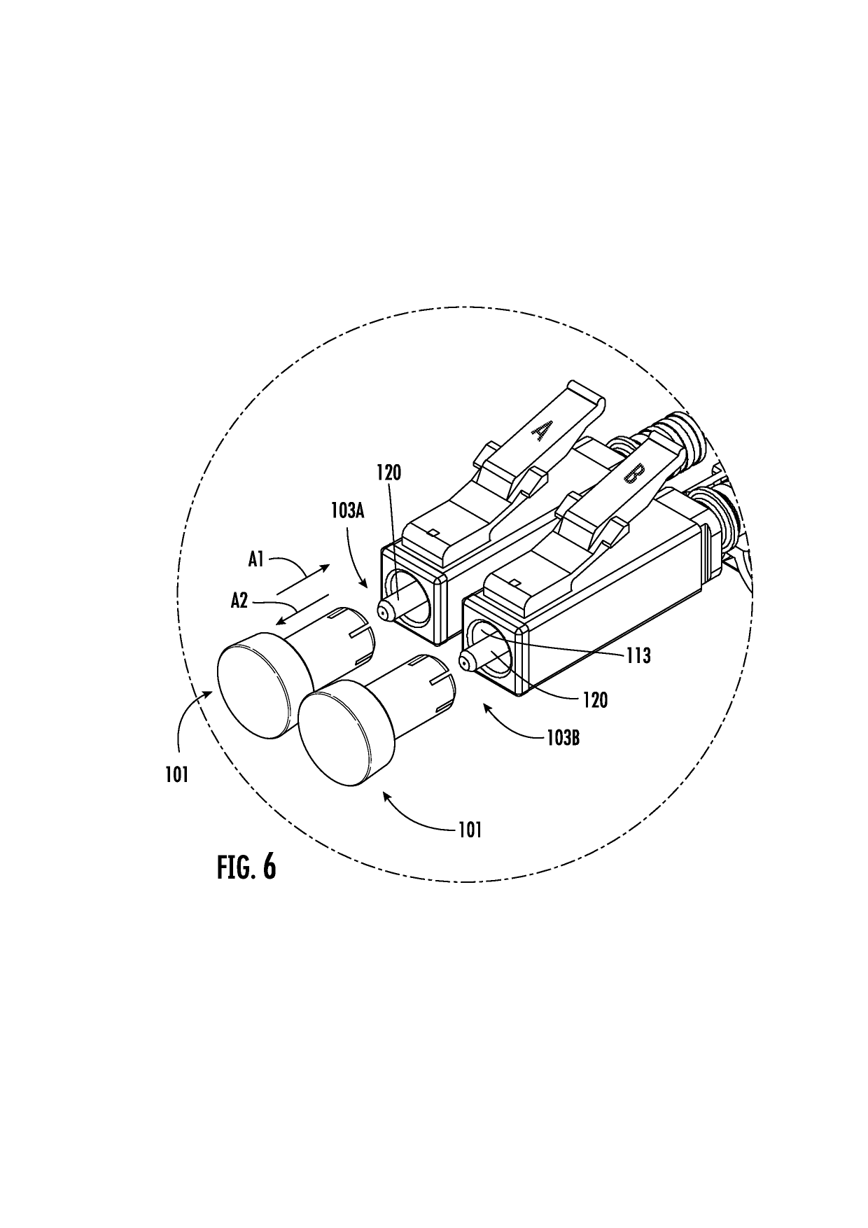

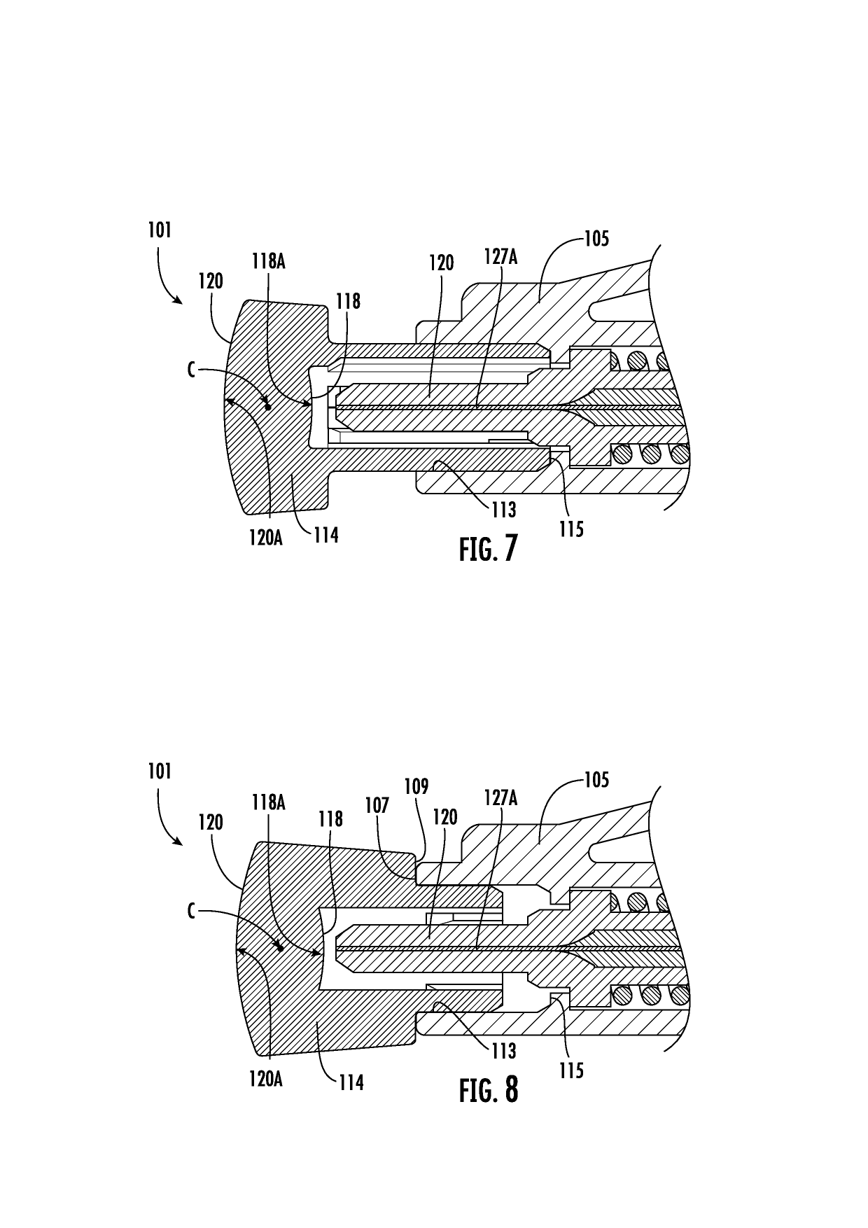

Referring now to FIGS. 6 and 7, a method of using and installing the dust cap 101 onto the optical fiber connector assembly 100 is shown. As shown in FIG. 6, dust caps 101 are moved along direction A1 and inserted into connectors 103A, 103B. In particular, first end 102 of dust cap 101 is inserted into recess 113 of connectors 103A, 103B. Within connector 103A, 103B, dust cap 101 is advanced along direction A1 until first end 102 contacts connector housing wall 115. When dust cap 101 is installed in this configuration as shown in FIG. 7, first end 102 is in contact with connector housing wall 115, and dust cap 101 is in an interference fit with connector housing 105. In this configuration, the first wall sections 108 deform, and upon deformation, dust cap 101 creates a seal with connector housing 105 to protect ferrule 120 and optical fiber 127A, 127B from external elements (e.g., debris, dust, etc.).

In an alternate embodiment, dust cap 101 is configured such that dust cap 101 is inserted into connector housing 105 until an exterior surface 109 of dust cap 101 contacts an exterior surface 107 of connector housing 105 as shown in FIG. 8. In this configuration, dust cap 101 engages connector housing 105 in an interference fit with the walls defining recess 113 of connector housing 105 without contacting a rear end of connector housing wall 115 as shown.

To remove dust cap 101, dust cap 101 is dislodged from connector 103A, 103B by applying a force onto dust cap 101 in the direction A2 (FIG. 6). In particular, dust cap 101 is pulled from second end 104 along direction A2 to dislodge dust cap 101 from connector housing 105. Once dislodged, dust cap 101 is removed by continuing to move along direction A2 until first end 102 is exterior to connector 103A, 103B.

There are many other alternatives and variations that will be appreciated by persons skilled in optical connectivity without departing from the spirit or scope of this disclosure. For at least this reason, the invention should be construed to include everything within the scope of the appended claims and their equivalents.

What is claimed is:

1. A dust cap for a fiber optic cable assembly that includes a fiber optic connector that includes a connector housing that houses at least one optical fiber and a ferrule that terminates the at least one optical fiber, the dust cap comprising:
a first end;
a second end opposite the first end;
a first wall section having a first thickness;
a second wall section adjacent to the first wall section, the second wall section having a second thickness, the second thickness being greater than the first thickness;
wherein the dust cap is configured to engage with the connector housing in an interference fit whereby at least one of the first wall section or the second wall section deforms.

2. The dust cap of claim 1, wherein the first wall section includes a slit that extends from the first end of the dust cap;
wherein the slit has a length less than about 5 mm.

3. The dust cap of claim 1, wherein the first wall section comprises a plurality of first wall sections, and the second wall section comprises a plurality of second wall sections; wherein each second wall section is adjacent to at least one of the plurality of first wall sections.

4. The dust cap of claim 1, further comprising a lensing element at the second end of the dust cap, the lensing element comprising a first curved surface proximate the second end and a second curved surface at the second end.

5. The dust cap of claim 4, wherein the first curved surface is concave relative to a center of the lensing element and the second curved surface is concave relative to the center of the lensing element.

6. The dust cap of claim 4, wherein the first curved surface is convex relative to a center of the lensing element and the second curved surface is concave relative to the center of the lensing element.

7. The dust cap of claim 4, wherein the first curved surface is concave relative to a center of the lensing element and the second curved surface is convex relative to the center of the lensing element.

8. The dust cap of claim 4, wherein the first curved surface is convex relative to a center of the lensing element and the second curved surface is convex relative to the center of the lensing element.

9. A dust cap for an optical connector, the dust cap comprising:
a first end;
a second end opposite the first end;
a plurality of first wall sections having a first thickness, each first wall section including a slit that extends from the first end of the dust cap; and
a plurality of second wall sections each adjacent to at least one of the plurality of first wall sections, the second wall section having a second thickness, the second thickness being greater than the first thickness.

10. The dust cap of claim 9, wherein the slit has a length less than about 5 mm.

11. The dust cap of claim 9, further comprising a lensing element at the second end of the dust cap, the lensing element comprising a first curved surface proximate the second end and a second curved surface at the second end;
wherein the first curved surface and the second curved surface each have an interior surface that face each other;
wherein the first curved surface is convex and the second curved surface is concave.

12. The dust cap of claim 9, wherein the dust cap is inserted into a fiber optic cable assembly that includes:
a fiber optic connector including a connector housing that houses at least one optical fiber and a ferrule that terminates the at least one optical fiber;
wherein an interference fit is formed between the dust cap and the connector housing such that the interference fit creates a seal between the connector housing and the dust cap to prevent debris from entering into the fiber optic connector.

13. The dust cap of claim 9, wherein the plurality of first wall sections deform when the dust cap is inserted into a fiber optic cable assembly and the dust cap engages with a connector housing of the fiber optic cable assembly.

14. The dust cap of claim 9, wherein the dust cap is inserted into a fiber optic cable assembly that includes:
a fiber optic connector including a connector housing that houses at least one optical fiber and a ferrule that terminates the at least one optical fiber;
wherein an exterior surface of the dust cap contacts an exterior surface of the connector housing.

15. A method of using and installing a dust cap for a fiber optic cable assembly that includes at least one optical fiber, a ferrule that terminates the at least one optical fiber, and a fiber optic connector that includes the ferrule, wherein the ferrule is housed within a connector housing of the fiber optic connector, the method comprising:
installing the dust cap in the connector housing, wherein an interference fit is formed between the dust cap and the connector housing to create a seal between the connector housing and the dust cap for preventing debris from entering into the fiber optic connector;
wherein the dust cap comprises:
a first end;
a second end opposite the first end;
a first wall section having a first thickness, wherein the first wall section includes a slit that extends from the first end of the dust cap; and
a second wall section adjacent to the first wall section, the second wall section having a second thickness, the second thickness being greater than the first thickness;
wherein when the dust cap forms interference fit with the connector housing, the first wall section deforms.

16. The method of claim 15, wherein the dust cap further comprises a lensing element at the second end of the dust cap, the lensing element comprising a first curved surface proximate the second end and a second curved surface at the second end.

17. The method claim 16, wherein the first curved surface is concave relative to a center of the lensing element and the second curved surface is concave relative to the center of the lensing element.

18. The method of claim 16, wherein the first curved surface is convex relative to a center of the lensing element and the second curved surface is concave relative to the center of the lensing element.

19. The method of claim 16, wherein the first curved surface is concave relative to a center of the lensing element and the second curved surface is convex relative to the center of the lensing element.

20. The method of claim 16, wherein the first curved surface is convex relative to a center of the lensing element and the second curved surface is convex relative to the center of the lensing element.
